(19) United States
(12) Patent Application Publication
(10) Pub. No.: US 2026/0028087 A1
(43) Pub. Date: Jan. 29, 2026

(54) QUICK RELEASE STRUCTURE FOR A BICYCLE

(71) Applicant: GLORY WHEEL ENTERPRISE CO., LTD., Taichung City (TW)

(72) Inventor: CHIEN-HAO LEE, Taichung City (TW)

(21) Appl. No.: 18/781,925

(22) Filed: Jul. 23, 2024

(51) Int. Cl. B62K 25/02

(52) U.S. Cl. CPC B62K 25/02; B62K 2206/00

(57) ABSTRACT

A quick release structure has a quick release handle, a shaft, a clamping element, and a clamping member. The shaft has a recess, a cavity, and a resilient member. The cavity is defined in an end of the shaft. The recess is defined in a bottom of the cavity. The cavity has a diameter gradually increasing from the end of the shaft toward the recess. The clamping element has two ends. One of the ends is connected with the quick release hand, and the other end extends into the recess. The clamping member is mounted around the clamping element. When the clamping element is combined with the quick release handle and the recess, at least a part of the clamping member is engaged with the cavity and two sides of the clamping member respectively abut against the bottom of the cavity and the quick release handle.

### FIELD OF INVENTION

The present invention relates to a quick release structure, particularly to a quick release structure for a bicycle to quickly combine a bicycle frame with a wheel.

### BACKGROUND OF THE INVENTION

A conventional quick release structure for a bicycle substantially comprises a quick release hand, a clamping element, and a shaft. A base is formed on an end of the quick release hand, and an inner surface is defined axially in the base. A through hole is axially defined through the shaft. An annular recess is define around an inner surface of the through hole, and a resilient member is mounted in the annular recess. The annular clamping element is an elongated rod having an even diameter. Two ends of the clamping element extend respectively into the inner recess of the quick release handle and the through hole of the shaft. The outer surface of the clamping element abuts against an inner surface of the annular resilient member. With such a structure, the quick release handle can be combined with the shaft by the clamping element for holding a wheel on a bicycle frame in position.

However, for the clamping element being able to being mounted around the shaft, the clamping element should has tolerance to make the clamping element have a diameter smaller than that of the through hole while the clamping element is manufactured. Thus, when a gap is formed between the clamping element and the shaft, the buffering effect and combination stability between the clamping element and the shaft is bad only by the resilient member being mounted around the clamping element. Therefore, noise will be generated by the shaking clamping element buffering against the inner surface of the shaft while the bicycle is riding. Accordingly, to improve the structure is necessary.

To overcome the shortcomings, the present invention tends to provide a quick release structure to mitigate or obviate the aforementioned problems.

### SUMMARY OF THE INVENTION

The objective of the present invention is to provide a quick release structure to improve the question of the noise generated by the shaking clamping element bumping against the inner surface of the shaft due to the tolerance of the clamping element.

To achieve the objective, the present invention provides a quick release structure having a quick release handle, a shaft, a clamping element, and a clamping member. The shaft has a recess, a cavity, an annular groove, and a resilient member. The cavity is defined in an end of the shaft. The recess is defined in a bottom of the cavity. The annular groove is defined in an inner surface of the cavity. The resilient member is mounted in the annular groove, wherein the cavity has a diameter gradually increasing from the end of the shaft toward the recess. The clamping element has two ends. One of the ends of the clamping element is connected with the quick release hand, and the other end of the clamping element extends into the recess. The clamping member is mounted around the clamping element and has an outer surface with a shape corresponding to a shape of an inner surface of the cavity in shape. When the clamping element is combined with the quick release handle and the recess, at least a part of the clamping member is engaged with the cavity and two sides of the clamping member respectively abut against the bottom of the cavity and the quick release handle.

Wherein, the clamping member is flat and has an axial length longer than an axial depth of the cavity to form a gap between the quick release handle and the shaft when the clamping member is mounted in the recess.

Wherein an annular limitation recess defined around an outer surface of the clamping element, and an inner surface of the limitation recess abut against the resilient member.

Wherein, the clamping member is made of a soft material.

Wherein, the shaft has an even diameter and a hexagonal cross section, the clamping member has a central hole for being mounting around the shaft having a circular or hexagonal shape.

With such features, the present invention has the following advantages:

First, when the clamping element is combined with the shaft, the resilient member and the clamping member both can provide a buffering and supporting effect to reduce the influence caused by the tolerance of the resilient member. The combination of the clamping element with the shaft is stable. The noise generated by the shake of the clamping element while the bicycle is riding will be reduced.

Second, with the conical recess, the clamping member will not be escaped from the recess when the shaft is detached from the clamping element.

### BRIEF DESCRIPTION OF THE DRAWINGS

FIG. 1 is a perspective view of a quick release structure in accordance with the present invention for combining a wheel with a bicycle frame;

FIG. 2 is a cross sectional side view of the quick release structure in FIG. 1;

FIG. 3 is an enlarged cross sectional side view of quick release structure in FIG. 2;

FIG. 4A is a side view of a first embodiment of a clamping member for a quick release structure in accordance with the present invention; and

FIG. 4B is a side view of a second embodiment of a clamping member for a quick release structure in accordance with the present invention.

### DETAILED DESCRIPTION OF THE PREFERRED EMBODIMENTS

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

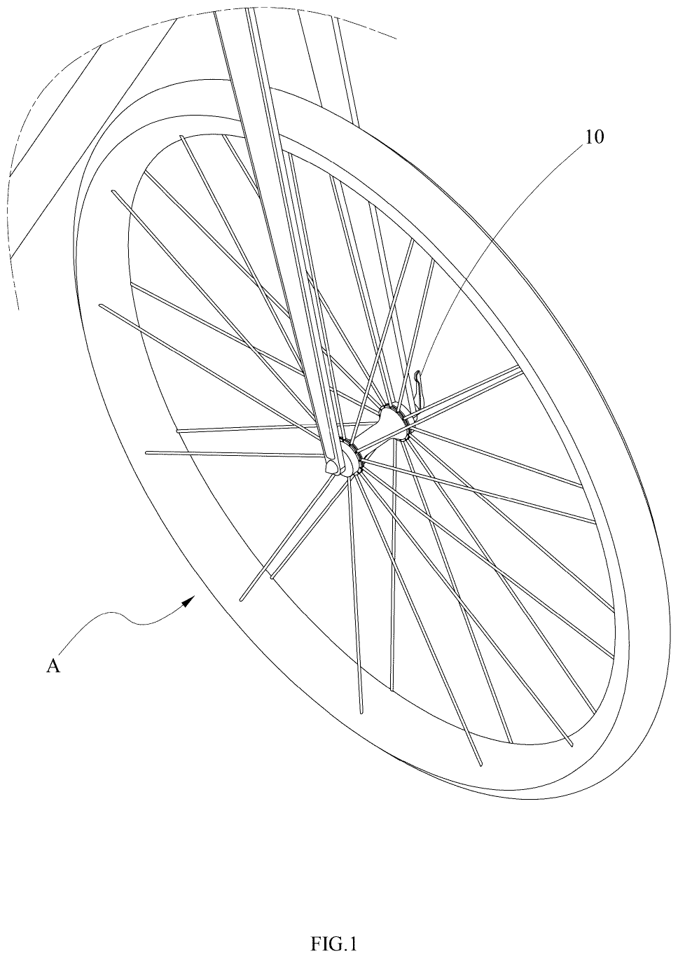

With reference to FIG. 1, a quick release structure for a bicycle in accordance with the present invention is mounted between a frame and a wheel of a bicycle A to quickly detaching the quick release structure from the frame by rotating the quick release structure. Thus, the wheel can be detached from the frame of the bicycle A. In addition, with rotating the quick release structure in reverse, the wheel can be combined securely with the frame of the bicycle A.

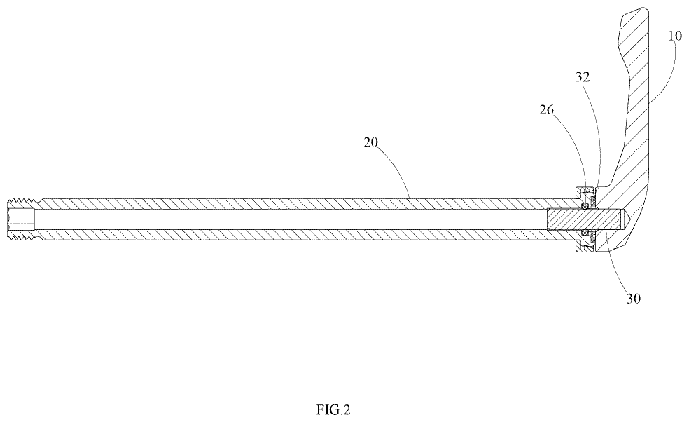

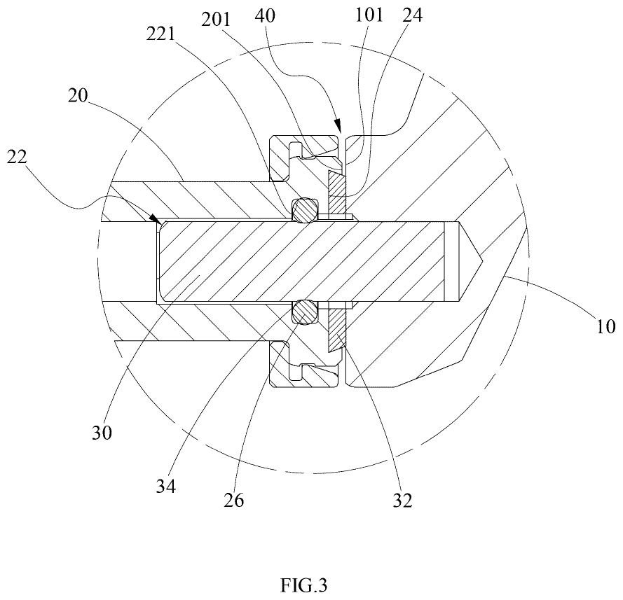

With reference to FIG. 2 and FIG. 3, the quick release structure in accordance with the present invention comprises a quick release handle 10, a shaft 20, and a clamping element 30.

A recess 22 is defined in an end 201 of the shaft 20. An annular groove 221 is defined around an inner surface of the recess 22. An annular resilient member 26 is mounted in the annular groove 221. Furthermore, a cavity 24 is defined in the end 201 of the shaft 22 and is co-axial with the recess 22. The cavity 24 has a diameter gradually increasing from the end 201 of the shaft 20 toward the recess 22.

The clamping element 30 has two ends, one of the two ends is combined with an end of the quick release handle 10, and the other end extends into the cavity 22. Wherein, a maximum diameter of the clamping element 30 is smaller a maximum diameter of the recess 22. Thus, the clamping element 30 can detachably extend into the recess 22. A flat clamping member 32 is mounted around the clamping element 30. An outer surface of the clamping member 32 has a shape corresponding to a shape of the conical inner surface of the cavity 24 in shape. Wherein, an axial length of the clamping element 30 is longer than an axial depth of the cavity 24.

When the clamping element 30 is combined with the quick release handle and the cavity 22, a part of the clamping member 32 is engaged with the cavity 24 because the outer surface of the clamping member has the shape corresponding to the shape of the inner surface of the cavity and the axial length of the clamping element 30 is longer than the depth of the cavity 24. Two sides of the clamping member 32 abut respectively against a bottom of the cavity 24 and the quick release handle 10, and a gap 40 is defined between the quick release handle 10 and the shaft 20.

With such an arrangement, when the clamping element is combined with the shaft 20, two contact supporting portions are formed between the clamping element 30 and the inner surface of the shaft 20. One portion is at the resilient member 24, and the other portion is at the clamping member 32 mounted around the clamping element 30 and engaging with the cavity 24. The two supporting portions can improve the stability of the combination between the clamping element 30 and the shaft 20 to reduce the influence caused by the tolerance of the clamping element 30. Accordingly, the noise generated by shake of the clamping element 30 while the bicycle is riding can be reduced.

In addition, when the clamping element 30 is detached from the shaft 20, the clamping member 32 will not be detached from the cavity 24 due to the conical inner surface of the cavity 24 that can limit a movement of the clamping member 32.

Because the axial length of the clamping element 30 is longer than the depth of the cavity 24, the clamping member 32 will extend out of the cavity 24 when the clamping 32 is held in the cavity 24. In addition, a gap 40 is formed between a base 101 of the quick release handle 10 and the end 201 of the shaft 20. Accordingly, the base 101 can be kept from in contact with the end 201 of the shaft to prevent generating noise, and the contact wear between the quick release handle 10 and the shaft 20 can also be reduced. The useful life of the quick release structure in accordance with the present invention can be prolonged.

With reference to FIG. 3, an annular limitation recess 34 is defined around the clamping element 30, and an inner surface of the limitation recess 34 abut against the resilient member 26. Thus, the position of the resilient member 26 can be limited by the annular groove 221 in cooperation with the limitation recess 34 to keep the resilient member 26 from moving arbitrarily.

The clamping member 32 is made of a soft material such as Nitrile Butadiene Rubber (NBR), Thermo-Plastic-Rubber material, TPR, or silicone. The soft material can improve the buffering effect of the clamping member 32 and can reduce noise.

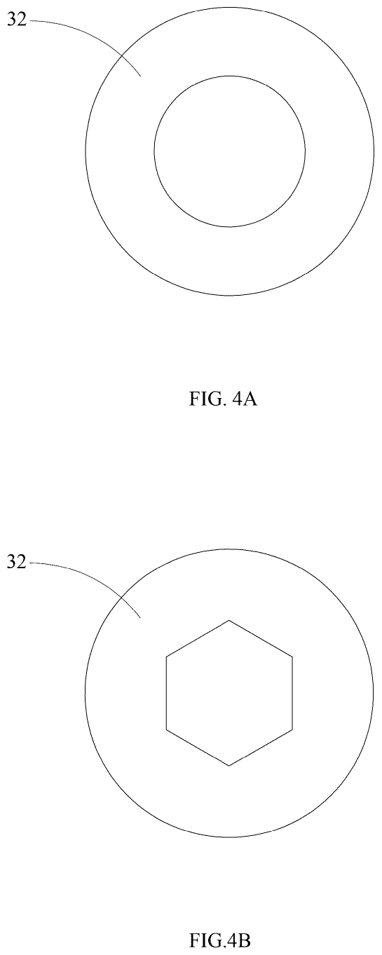

With reference to FIG. 3, FIG. 4A, and FIG. 4B, a central hole is defined axially through the clamping member 32 and is mounted around the clamping element 30. The shape of the central hole is not limited in the present invention. The minimum diameter of the central hole is equal to an outer diameter of any position of the clamping element 30, so that the clamping member 32 can support any position of the clamping element 30. Preferably, the shape of the central hole corresponding to a shape of the cross sectional of any position of the clamping element 30, such that the central hole can enclose any position of the clamping element 30. In this embodiment, the clamping element 30 may be a cylinder or has a hexagonal cross section, and the central hole may be circular or hexagonal in shape.

What is claimed is:

1. A quick release structure for a bicycle comprising:
a quick release handle;
a shaft comprising
a cavity defined in an end of the shaft;
a recess defined in a bottom of the cavity;
an annular groove defined in an inner surface of the cavity; and
a resilient member mounted in the annular groove, wherein the cavity has a diameter gradually increasing from the end of the shaft toward the recess;
a clamping element having two ends, one of the ends of the clamping element connected with the quick release hand, and the other end of the clamping element extending into the recess; and
a clamping member mounted around the clamping element and having an outer surface with a shape corresponding to a shape of an inner surface of the cavity in shape, wherein when the clamping element is combined with the quick release handle and the recess, at least a part of the clamping member is engaged with the cavity and two sides of the clamping member respectively abut against the bottom of the cavity and the quick release handle.

2. The quick release structure as claimed in claim 1, wherein the clamping member is flat and has an axial length longer than an axial depth of the cavity to form a gap between the quick release handle and the shaft when the clamping member is mounted in the recess.

3. The quick release structure as claimed in claim 2, wherein an annular limitation recess defined around an outer surface of the clamping element, and an inner surface of the limitation recess abut against the resilient member.

4. The quick release structure as claimed in claim 3, wherein the clamping member is made of a soft material.

5. The quick release structure as claimed in claim 4, wherein the shaft has an even diameter and a hexagonal cross section, the clamping member has a central hole for being mounting around the shaft having a circular or hexagonal shape.
